(19) United States
(12) Patent Application Publication
(10) Pub. No.: US 2011/0073132 A1
(43) Pub. Date: Mar. 31, 2011

(54) DENTAL FLOSS BOW

(76) Inventor: CHUNMEI CHEN, TUCSON, AZ (US)

(21) Appl. No.: 12/837,232

(22) Filed: Jul. 15, 2010

(30) Foreign Application Priority Data
Sep. 30, 2009 (CN) 200910019078.7

(51) Int. Cl. A61C 15/00

(52) U.S. Cl. 132/323

(57) ABSTRACT

The invention presents a Dental Floss Bow to solve existent flossing problems. The Dental Floss Bow grips dental floss by adjusting the clearance gap between Taper Hole Body and Cone Body, which is achieved by thread engagement between Grip Nut and Taper Hole Body (which has male thread at one end). The Dental Floss Bow can also tension dental floss by a Tension Nut, which pulls the Taper Hole Body and Cone Body together. With the functions of gripping and tensioning the invention is simple to operate, handy and effective. A Floss Bin is integrated into the invention.

### TECHNICAL SCOPE

The invention relates to teeth cleaning tools, more specifically, a flossing tool with functions such as tensioning dental floss.

### TECHNOLOGY BACKGROUND

In general there are three types of flossing tools at present: a disposable dental floss fork with a short piece of floss attached to a small plastic handle; a demountable dental floss fork (which often belongs to a multi-function upscale teeth cleaning tool) with floss winding (so floss can be replaced); and most commonly, the user's fingers, sometimes assisted with a nylon needle which allows floss passing between teeth.

The first type is environmentally unfriendly on disposal, hard to manipulate for proper force, and difficult to thread with floss.

At present, dental floss appears in markets as disk-shaped floss rolls in plastic containers.

The second and third types both require a cut-off piece of floss wound onto a dental floss fork or around one's fingers. In the winding process floss easily gets dirty and causes hygiene issues. Part of every piece of floss cut is wasted, and disposing the floss containers is environmentally unfriendly.

### INVENTION CONTENT

The invention provides a Dental Floss Bow to solve problems caused by the abovementioned three types of teeth cleaning tools. The invention has functions of gripping and tensioning dental floss. The invention is simple to operate, handy, and effective. A floss bin is integrated in the invention.

The technical scheme of the invention for solving the abovementioned problems is a Dental Floss Bow, which is composed of Bow Body, Taper Hole Body, Grip Nut, Cone Body and Tension Nut, and Bin Lid, which is thread-engaged with Floss Bin.

The abovementioned Bow Body has a grooved U-Fork on top, and a Floss Bin with floss roll at the bottom. Between U-Fork and Floss Bin, the Bow Body has, in the order of position, Square Hole (leaving room for lower part of Cone Body), Wicket (leaving room for Tension Nut), and Round Hole (passage for Cone Body).

The abovementioned Taper Hole Body has Taper Hole at the top and Dowel Screw at the bottom.

The abovementioned Cone Body has Cone at the top, Cylinder, Shoulder and Thread Shaft in the middle, and Square Pin at the bottom. There is Floss Passage through bottom of Square Pin and side of Cone.

The abovementioned Cone Body is assembled into Square Hole of Bow Body through its Square Pin. The Taper Hole Body is assembled onto Cone and Cylinder of Cone Body through its Taper Hole, with clearance gap to contain floss.

The abovementioned Grip Nut is thread-engaged with Dowel Screw at the bottom of Taper Hole Body. The Tension Nut is thread-engaged with Thread Shaft of Cone Body, which also fixes Shoulder of Cone Body at the lower surface of Tension Nut. Tension Nut is vertically limited by Wicket.

The invention has the following additional characteristics:

Slide Rails, assembled inside Slide Grooves, are on sides of Taper Hole Body; and that Slide Grooves are on sides of Bow Body, respectively.

Horizontal Fillister is between Taper Hole and Dowel Screw of Taper Hole Body.

There is misalignment between Taper Hole and Dowel Screw of Taper Hole Body.

There is Vertical Opening as floss inlet on the Taper Hole of Taper Hole Body.

U-Fork on top of Bow Body is tilting type.

There is Bin Lid, thread-engaged with Floss Bin.

The invention has the following merits compared to present techniques:

1. The thread engagement between Grip Nut and Taper Hole Body controls the clearance gap between Taper Hole of Taper Hole Body and Cone of Cone Body in order to grip floss. The thread engagement between Tension Nut and Thread Shaft of Cone Body can move Taper Hole Body and Cone Body together vertically, in order to adjust tension on floss. Therefore, users only need to turn Grip Nut or Tension Nut in order to grip or tension floss. The operation is easy and convenient.

2. With the aid of floss passage on Cone Body, grooves on Bow Body, Vertical Opening on Taper Hole Body as floss inlet, etc., the pulling and fixing procedures of floss become simple and reliable, bringing convenience to users.

3. Floss roll is contained inside of Floss Bin, which brings simple, long-lasting and sanitary usage.

4. The use of this invention of Dental Floss Bow saves flask materials: only economy bulk flask is needed.

### DESCRIPTION WITH ATTACHED FIGURES

The following is detailed description of the invention, with attached figures and implementation cases.

FIG. 1. main view of Dental Floss Bow;

FIG. 2. lateral view of Dental Floss Bow;

FIG. 3. cutaway view of D-D in FIG. 2;

FIG. 4. cutaway view of B-B in FIG. 1;

FIG. 5. cutaway view of A-O-A in FIG. 4;

FIG. 6. cutaway view of C-C in FIG. 1;

FIG. 7. main view of Bow Body and cutaway view of G-O-G in FIG. 8;

FIG. 8. lateral view of Bow Body and cutaway view of F-F in FIG. 7;

FIG. 9. cutaway view of E-E in FIG. 7;

FIG. 10. cutaway view of G-G in FIG. 7;

FIG. 11. Nylon Needle;

FIG. 12. main view of Taper Hole Body;

FIG. 13. lateral view of Taper Hole Body;

FIG. 14. top plan view of Taper Hole Body;

FIG. 15. semi-cutaway view of Grip Nut;

FIG. 16. radial view of Cone Body;

FIG. 17. enlarged view of coordination among Taper Hole Body, Grip Nut, and Cone Body, before dental floss is tensioned;

FIG. 18. enlarged view of coordination among Taper Hole Body, Grip Nut, and Cone Body, after dental floss is tensioned;

FIG. 19. schematic diagram of dental floss being gripped by Taper Hole Body and Cone Body.

1. Bow Body; 1a. Floss Groove; 1b. U-Fork; 1c. Wicket; 1d. Floss Bin; 1e. Slide Groove; 1f. Round Hole; 1g. Square Hole;

2. Taper Hole Body; 2a. Taper Hole; 2b. Dowel Screw; 2c. Slide Rail; 2d. Vertical Opening; 2e. Horizontal Fillister;

3. Grip Nut; 3a. Counterbore Hole;

4. Cone Body; 4a. Cone; 4b. Cylinder; 4c. Thread Shaft; 4d. Square Pin; 4e. Floss Passage; 4f. Shoulder;

5. Tension Nut; 6. Bin Lid; 7. Nylon Needle; 8. floss; 9. floss roll.

### Execution Method

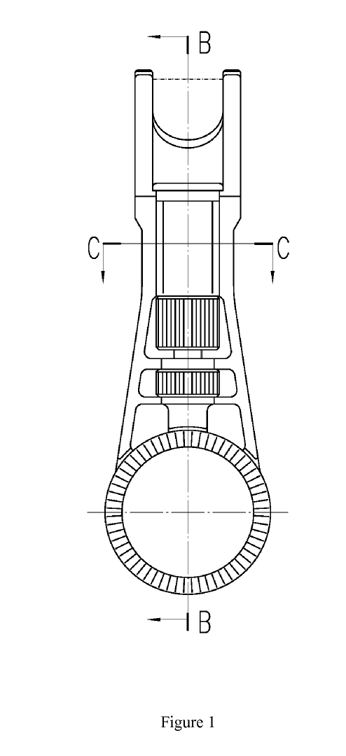

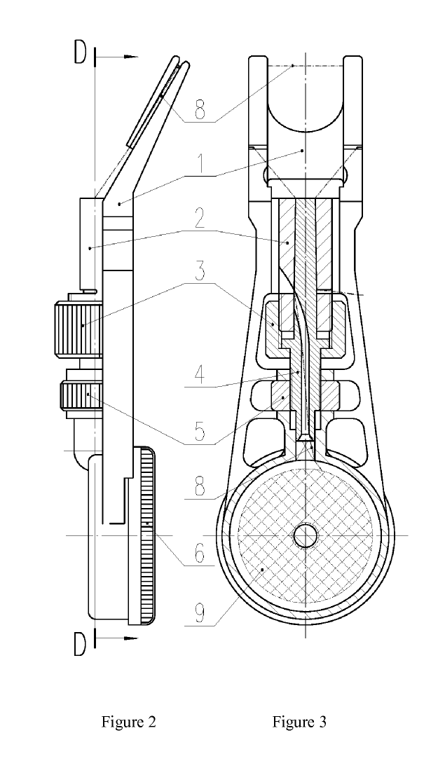

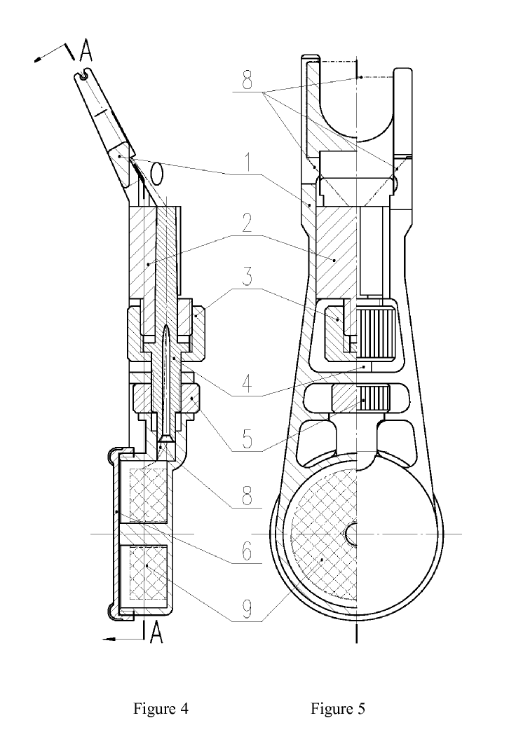

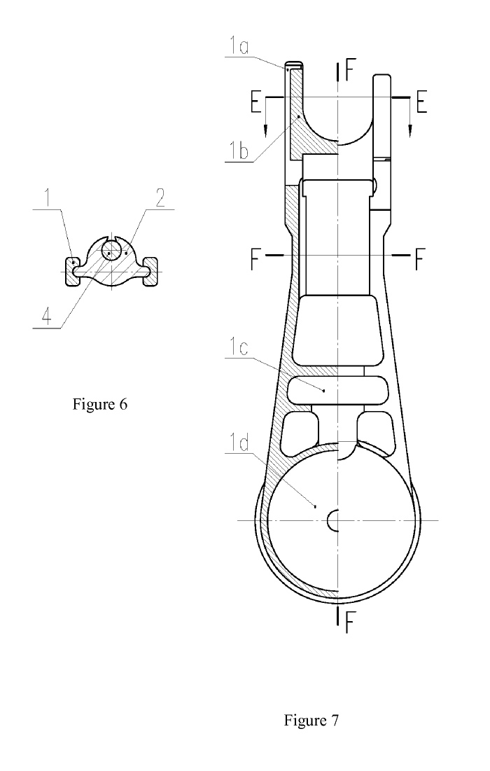

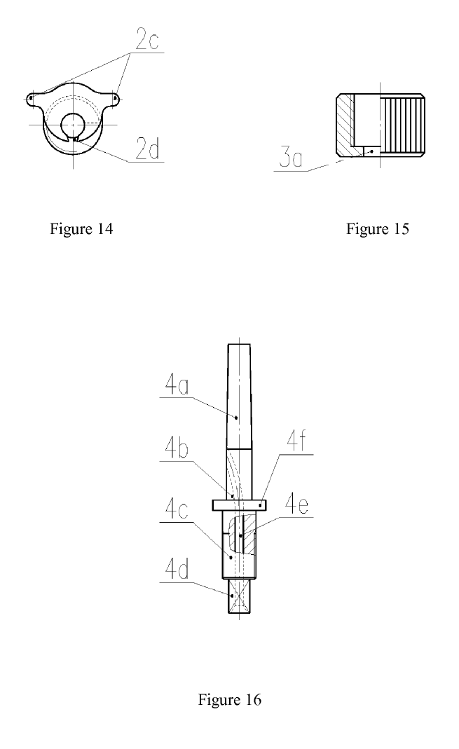

The invention of Dental Floss Bow, as shown in FIG. 1-19, is composed of Bow Body (1), Taper Hole Body (2), Grip Nut (3), Cone Body (4), Tension Nut (5), and Bin Lid (6), with Nylon Needle (7) as attachment. All the above units are made of plastics or nylon.

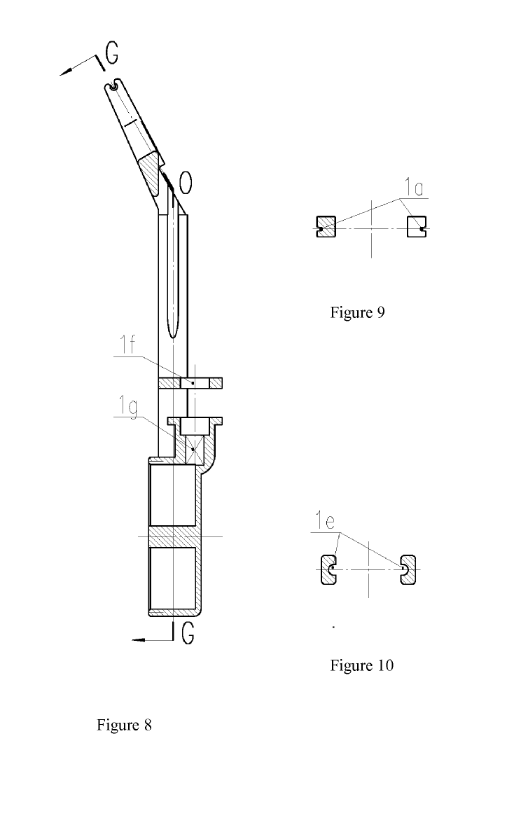

The top of Bow Body (1) is the U-Fork (1b) with Floss Groove (1a) in it (FIG. 7-10); the middle of Bow Body (1) are two Slide Grooves (1e); and the bottom of Bow Body (1) is Floss Bin (1d), top of which is Square Hole (1g) mating with Square Pin (4d) of Cone Body (4) (FIG. 8). The Wicket (1c) above Floss Bin (1d) is to leave space for Tension Nut (5) and the Round Hole (1f) is the passage for Cone Body (4). Bin lid (6) is screwed onto Floss Bin (1d). Floss roll (9) is inside of Floss Bin (1d). The U-Fork (1b) is of tilting type, with tilt angle of 30°˜45° in general. 30° is chosen for convenience of flossing.

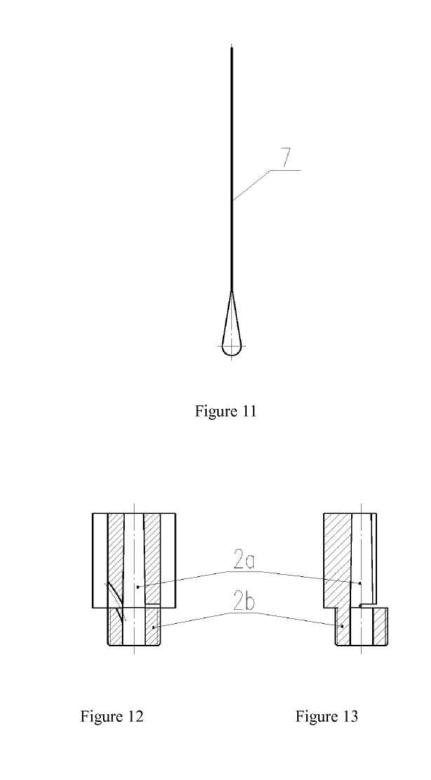

As shown in FIG. 12-14, upper side of Taper Hole Body (2) has a Vertical Opening (2d) for floss moving in, Taper Hole (2a) in the middle, and two Slide Rails (2c) on sides. Lower side of Taper Hole Body (2) is Dowel Screw (2b). There is misalignment between the abovementioned Taper Hole (2a) and Dowel Screw (2b) for easy installation of Slide Rails (2c) into Slide Grooves (1e).

As shown in FIG. 16, the upper side of Cone Body (4) is Cone (4a) with the shape of cut-top-cone. Its function is to grip floss (8) by changing the clearance gap. The other components of Cone Body (4), in the order of position, are Cylinder (4b) with Shoulder (4f), Square Pin (4d), and Floss Passage (4e) between Square Pin (4d) and Cylinder (4b).

As shown in FIG. 1-6, to assemble, the abovementioned Square Pin (4d) inserts inside of Square Hole (1g), which belongs to Bow Body (1), so as to be stabilized. Taper Hole (2a) is slipped onto Cone (4a) and Cylinder (4b), as to assemble Taper Hole Body (2) and Cone Body (4), between which exists clearance gap, as shown in FIG. 19.

The abovementioned Grip Nut (3) is thread engaged with Dowel Screw (2b) of Taper Hole Body (2); the abovementioned Tension Nut (5) is thread engaged with Thread Shaft (4c) of Cone Body (4), which fixes the Shoulder (4f) onto the inner surface of Grip Nut (3) (because of the Counterbore Hole (3a) at the bottom of Grip Nut (3) as shown in FIG. 15). The abovementioned Tension Nut (5) is vertically limited by Floss Bin (1d), with only freedom of rotation, and cannot move up and down. Only Cone Body (4) can move vertically.

The principle of operation and procedure of flossing are the following: put floss roll (9) into Floss Bin (1d), use Nylon Needle (7) to induce floss (8) through Floss Passage (4e), force floss (8) into Taper Hole (2a) through Vertical Opening (2d), circle floss (8) around U-Fork (1b) along the left and right Floss Grooves (1a), then force floss (8) into Taper Hole (2a) through Vertical Opening (2d) again.

Thread engagement between Grip Nut (3) and Dowel Screw (2b) of Taper Hole Body (2) can change the clearance gap between Taper Hole (2a) and Cone (4a), or between Taper Hole Body (2) and Cone Body (4), so as to grasp floss (8). Thread engagement between Thread Shaft (4c) and Tension Nut (5) can be utilized to push or pull Taper Hole Body (2) and Cone Snail (4), so as to adjust the tension on floss (8).

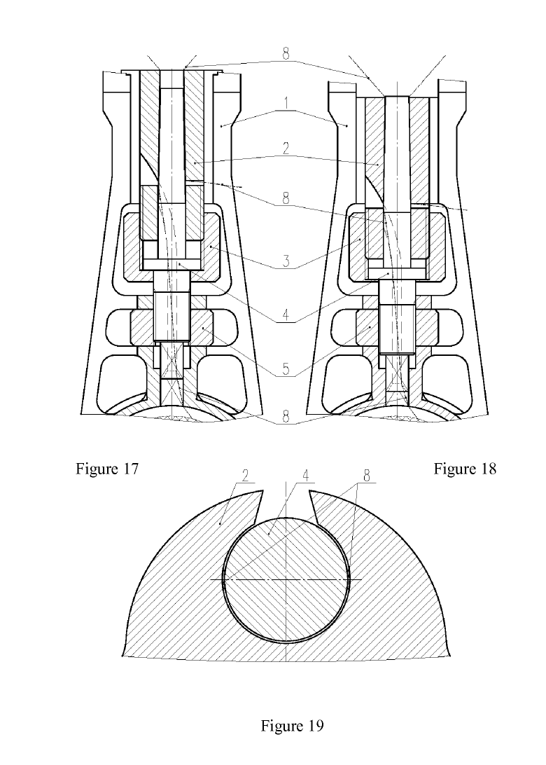

Relative axle movement between Taper Hole Body (2) and Cone Body (4) by rotating Grip Nut (3) can reduce the clearance gap between Taper Hole (2a) and Cone (4a), so as to grasp floss (8), as shown in FIGS. 17-19.

Since that Shoulder (4f) is fixed onto the inner surface of Grip Nut (3), and that Grip Nut (3) and Taper Hole Body (2) are connected, when Tension Nut (5) is rotated, Taper Hole Body (2), Grip Nut (3) and Cone Body (4) can move together with two Slide Rails (2c) along two Slide Grooves (1e), so as to stretch floss (8) along U-Fork (1b), as shown in FIG. 18. Taper Hole Body (2), Grip Nut (3) and Cone Body (4) move together downward when floss is tensioned.

Floss tension on U-Fork (1b) can be adjusted any time by rotation of Tension Nut (5). When floss (8) on U-Fork (1b) is worn, the clearance gap between Taper Hole (2a) and Cone (4a) can be enlarged by counter-rotating Grip Nut (3), so the broken floss can be removed and new floss can be pulled and mounted onto U-Fork (1b) according to abovementioned procedure (but only “force floss (8) into Taper Hole (2a) through Vertical Opening (2d) again”).

The abovementioned is only application examples of this invention, not the limit of other forms of the invention. Any technician in related fields can possibly utilize the above-revealed technical content to remodel and build equivalent applications. However, any uncomplicated modification, equivalent change and remodel, based on the virtue technique in this invention and implement cases, is prohibited by the patent.

1. A type of Dental Floss Bow, which is composed of Bow Body, Taper Hole Body, Grip Nut, Cone Body and Tension Nut.
The abovementioned Bow Body has a grooved U-Fork on top, and a Floss Bin with floss roll at the bottom. Between U-Fork and Floss Bin, the Bow Body has, in the order of position, Square Hole (leaving room for lower part of Cone Body), Wicket (leaving room for Tension Nut), and Round Hole (passage for Cone Body).
The abovementioned Taper Hole Body has Taper Hole at the top and Dowel Screw at the bottom.
The abovementioned Cone Body has Cone at the top, Cylinder, Shoulder and Thread Shaft in the middle, and Square Pin at the bottom. There is Floss Passage through bottom of Square Pin and side of Cone.
The abovementioned Cone Body is assembled into Square Hole of Bow Body through its Square Pin. The Taper Hole Body is assembled onto Cone and Cylinder of Cone Body through its Taper Hole, with clearance gap to contain floss.
The abovementioned Grip Nut is thread-engaged with Dowel Screw at the bottom of Taper Hole Body. The Tension Nut is thread-engaged with Thread Shaft of Cone Body, which also fixes Shoulder of Cone Body at the lower surface of Tension Nut. Tension Nut is vertically limited by Wicket.

2. The characteristic of Dental Floss Bow, by claim 1, is that Slide Rails, assembled inside Slide Grooves, are on sides of Taper Hole Body; and that Slide Grooves are on sides of Bow Body, respectively.

3. The characteristic of Dental Floss Bow, by claim 1, is that Horizontal Fillister is between Taper Hole and Dowel Screw of Taper Hole Body.

4. The characteristic of Dental Floss Bow, by claim 3, is the misalignment between Taper Hole and Dowel Screw of Taper Hole Body.

5. The characteristic of Dental Floss Bow, by claim 4, is Vertical Opening as floss inlet on the Taper Hole of Taper Hole Body.

6. The characteristic of Dental Floss Bow, by claims 1-5, is that U-Fork on top of Bow Body is tilting type.

7. The characteristic of Dental Floss Bow, by claim 6, is Bin Lid thread-engaged with Floss Bin.
